(19) United States
(12) Patent Application Publication
(10) Pub. No.: US 2005/0273272 A1
(43) Pub. Date: Dec. 8, 2005

(54) System and method for laboratory-wide information management

(75) Inventors: Michael M. Brando, Los Gatos, CA (US); Ravindra S. Kuchibhotla, Cupertino, CA (US); Janet M. Adams, Los Gatos, CA (US)

Correspondence Address: HARNESS, DICKEY & PIERCE, P.L.C., P.O. BOX 828, BLOOMFIELD HILLS, MI, 48303, US

(73) Assignee: Applera Corporation, a Delaware Corporation, Foster City, CA (US)

(21) Appl. No.: 11/113,447

(22) Filed: Apr. 22, 2005

Related U.S. Application Data
(60) Provisional application No. 60/564,910, filed on Apr. 22, 2004.

(51) Int. Cl. G06F 19/00

(52) U.S. Cl. 702/19

(57) ABSTRACT

A laboratory information management system includes a process template manager that creates a process template from a plurality of activities. A workflow template generator generates a workflow template from the process template. A process manager starts a process run according to the process template. A workflow component schedules workflow according to the workflow template. An activity manager controls execution of an activity according to the process template and the workflow template.

### CROSS-REFERENCE TO RELATED APPLICATIONS

This application claims the benefit of U.S. Provisional Application No. 60/564,910 filed on Apr. 22, 2004. The disclosure of the above application is incorporated herein by reference in its entirety for any purpose.

### FIELD

The present teachings relates to a system and method for assisting in the automation and management of small to large scale processes and operation in biological genomic laboratories.

### BACKGROUND

A number of laboratory analysts can repeatedly perform a specific set of instructions on a given type of objects. The set of instructions are typically governed by a certain process and/or protocol. An automated system that provides control over pre-configured process and protocol promotes efficiency and eliminates the possibility of errors in the laboratory. Controlling laboratory instruments by pre-configuring instrument instructions can reduce the human interaction necessary in a laboratory. In the age of advanced computer technology, an automated laboratory information management system is necessary to control the flow of activities performed in a laboratory according to a defined process and protocol.

### SUMMARY

In accordance with the present teachings, a laboratory information management system includes a process template manager that creates a process template from a plurality of activities. A workflow template generator generates a workflow template from the process template. A process manager starts a process run according to the process template. A workflow component schedules workflow according to the workflow template. An activity manager controls execution of an activity according to the process template and the workflow template.

Further areas of applicability of the present teachings will become apparent from the detailed description provided hereinafter. It should be understood that the detailed description and specific examples, while indicating the various embodiments, are intended for purposes of illustration only and are not intended to limit the scope of the innovation.

### BRIEF DESCRIPTION OF THE DRAWINGS

The present teachings will become more fully understood from the detailed description and the accompanying drawings, wherein:

FIG. 1 is a sample flow diagram for a process of a genotyping laboratory;

FIG. 2 is a laboratory-wide information management system workflow;

FIG. 3 is a block diagram illustrating a lab management software system;

FIG. 4 is a sequence diagram illustrating steps for creating a Process Template and a Workflow Template;

FIG. 5 is a sequence diagram illustrating steps for initiating a process in a lab management software system;

FIG. 6 is a sequence diagram illustrating steps for starting an Activity;

FIG. 7 is a sequence diagram illustrating steps for concluding an Activity;

FIG. 8 is a sequence diagram illustrating steps for querying Activities and objects of a laboratory management system; and

FIGS. 9-16 are views of graphical user interfaces and complimentary visualization methodology according to the present teachings;

FIG. 17 is a table representing a history tree for a new version of a template; and

FIG. 18 is a table representing a history tree new version generated from a modified version of a template.

### DETAILED DESCRIPTION OF THE PREFERRED EMBODIMENTS

The following description is merely exemplary in nature and is in no way intended to limit the methods, their application, or uses. For purposes of clarity, the same reference numbers will be used in the drawings to identify the same elements.

The present teachings discuss a laboratory-wide software system that can assist in the automation and management of small to large scale processes and operations in biological and genomic laboratories. Software encompasses subsystems such as process configuration and process control management, workflow management, sample management, assay management, result management, report management, and the integration of instruments and robotics. These subsystems work in concert with one another to form a complete product.

By using tools provided by the software, laboratory personnel can describe typical processes and workflows that occur in their laboratory in terms of Activities. Activities are units of work to be performed. That is, each activity represents a particular task or operation that laboratory personnel or instrumentation can perform. A representative activity might be “Get Samples” where a laboratory technician is instructed to retrieve one or more specimen samples from a storage location such as a freezer. Another might be “Perform PCR” where a plate full of samples is analyzed on an Applied Biosystems 7900HT instrument. Such activities can also be grouped together to form a Protocol. Protocols are useful when certain operations are common to multiple processes.

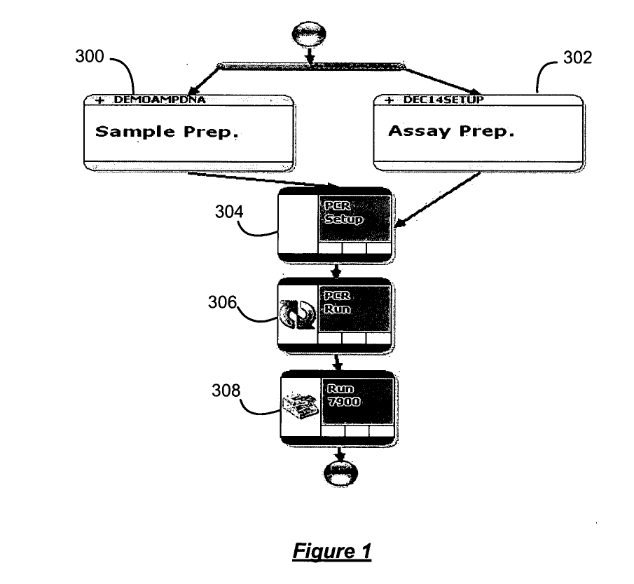

Aspects of the present teachings can be further understood from the following examples, which should not be construed as limiting the scope of the present teachings in any way. FIG. 1 shows a typical process in a genotyping laboratory where samples are placed into a process that can prepare them for analysis on a 7900 instrument. The target samples must first be prepared; that is specimen samples must undergo a series of operations to extract and purify their DNA so that these segments of DNA can undergo a PCR experiment and then analysis on the 7900 instrument. In addition, assays must be prepared and added to the samples prior to the PCR step. Lastly, the combined sample and assays are placed onto the 7900 instrument and the samples are analyzed.

In this example, all of the steps required to perform the operations related to a sample preparation have been grouped into a protocol 300 called “Sample Prep” 300. Likewise, the same has been done for all steps in an “Assay Prep” protocol 302. Following these two procedures, the samples can be added to the assays in an activity 304 called “PCR Setup”, those samples can then undergo a PCR procedure represented by an activity 306 called “PCR Run” and then the samples can be analyzed on the 7900 instrument using an analysis activity 308 that can either instruct a lab technician to run the instrument or automatically run the instrument, with automatic data collection and analysis from the instrument being an option as well.

Once the Activities have been defined in the software, laboratory personnel can create new processes and apply these processes to samples arriving in the laboratory. The Software can maintain the list of samples and the appropriate steps that each of these samples need to undergo in order to complete the process. Technicians can be notified of the work they have to perform, and the underlying workflow and process management subsystem can progress each sample as its relevant unit of work is first scheduled and subsequently completed. Laboratory personnel do not have to understand or be aware of the whole process, just the particular portions of the work which they have been assigned to do. Similarly, instrument setup does not necessarily have to be done since the software can automatically download instructions to the (supported) instrument along with the necessary sample and run data needed for the instrument to perform its experiment or run. In such a case, the laboratory personnel simply have to carry the samples over to the instrument, place them on in the beginning, and remove them when they are finished.

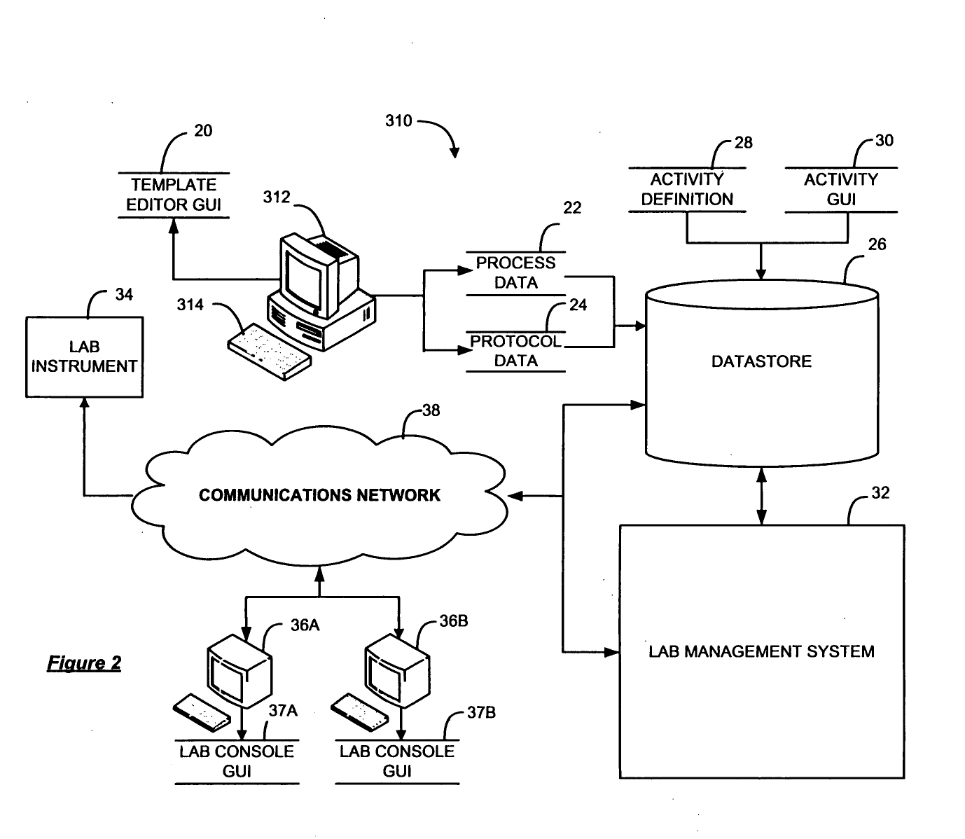

Referring now to FIG. 2, a Laboratory-Wide Information Management System is shown generally at 310. Within the system, Process Template Editor 312 receives user input from peripheral device 314. Peripheral device can be a keyboard 314, a mouse (not shown), and/or a scanner (not shown). Process Template Editor 312 provides output data 20 to a user in the form of a graphical user interface (GUI). Process Template Editor 312 stores all data inputs in the form of Process Data 22 or Protocol Data 24 in datastore 26. Activity definitions 28 and Activity GUIs 30 are provided by an independent activity developer and stored in datastore 26. Lab Management System 32 communicates with datastore 26, at least one lab instrument 34, and at least one Lab Console shown as 36A and 36B through a communications network 38. Lab Console provides output to a user in the form of a graphical user interface shown as Lab Console GUI 37A and 37B. Lab Management System 32 includes the Software of the present teachings.

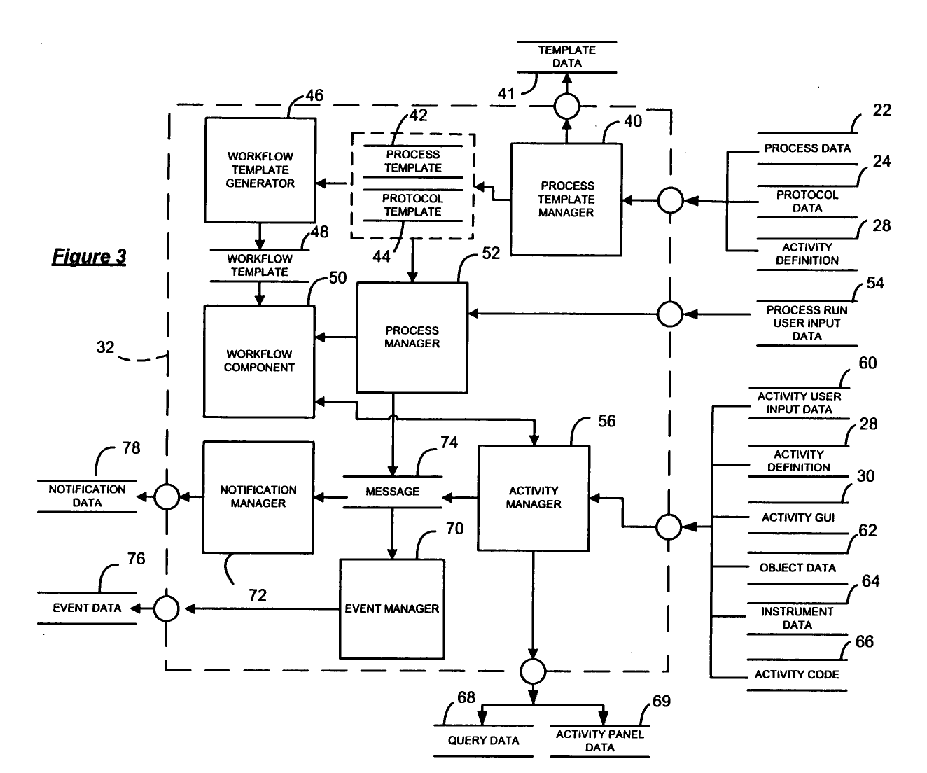

Referring now to FIG. 3, a dataflow diagram of subsystems of Lab Management System 32 is shown. Process Template Manager 40 is receptive of data inputs Process Data 22, Protocol Data 24 and Activity Definition 28. Process Template Manager 40 communicates with the Process Template Editor to create Process Template 42 and/or Protocol Template 44 from predefined Activity Definition 28. Process Template Manager 40 edits predefined Protocols, stores Process and/or Protocol Templates by generation and version, and generates a history tree according to the generation and version. Process Template Manager 40 outputs template data 41 to the user via Process Template Editor.

Workflow Template Generator 46 is receptive of Process Template 42 and/or Protocol Template 44 created by Process Template Manager 40. Workflow Template Generator 46 generates Workflow Template 48 corresponding to the input received. Workflow Template 48 can be used by Workflow Component 50 to create Workflow Job Queues and Job Request Schedules.

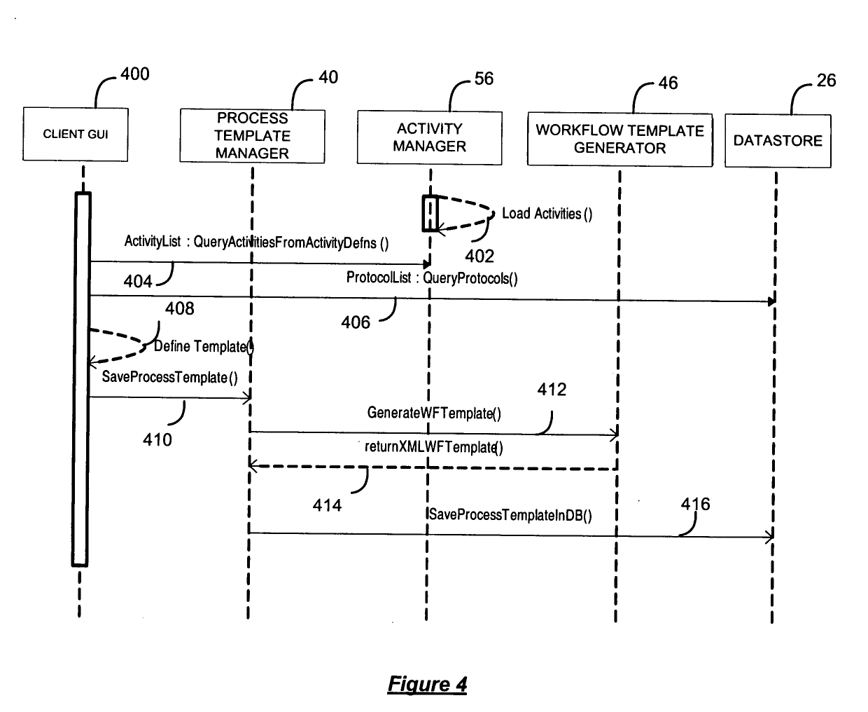

Turning now to FIG. 4, a sequence diagram illustrates interaction of a client 400, Process Template Manager 40, Workflow Template Generator 46, Activity Manager 56 56, and datastore 26. This interaction example illustrates the aforementioned sequence of steps in more detail. Activity Definitions are loaded by Activity Manager 56 at 402. At 404, client 400 initiates a query for Activity Definitions to Activity Manager 56. At 406, client 400 initiates a query for Protocol Templates to datastore 26. Client 400 then proceeds to define a Process Template at 408. Upon completion of the template, client 400 sends a request to save the template to Process Template Manager 40 at 410. Process Template Manager 40 sends a request to Workflow Template Generator 46 at 412 to create a corresponding Workflow Template. A Workflow Template is sent back to Process Template Manager 40 at 414. Process Template Manager 40 then saves the completed Process Template in datastore 26 at 416.

Returning to FIG. 3, Process Manager 52 is receptive of Process Run Data 54 which is supplied by a user via Process Run GUI. Based on Process Run Data 54, Process Manager 52 can configure and start a Process/Protocol Run, which in turn retrieves the appropriate Workflow Template 48 from the datastore and starts the appropriate Workflow instance for the retrieved Workflow Template 48. Depending on the nature of Process Run Data 54 entered, Process Manager 52 can query a Process and a Process Run; manage the interaction with Workflow Component 50; registers rules with an Event Manager 70; publish events regarding Process and Process Run status; and manage Process and Process Run persistence in the datastore for tracking and history purposes.

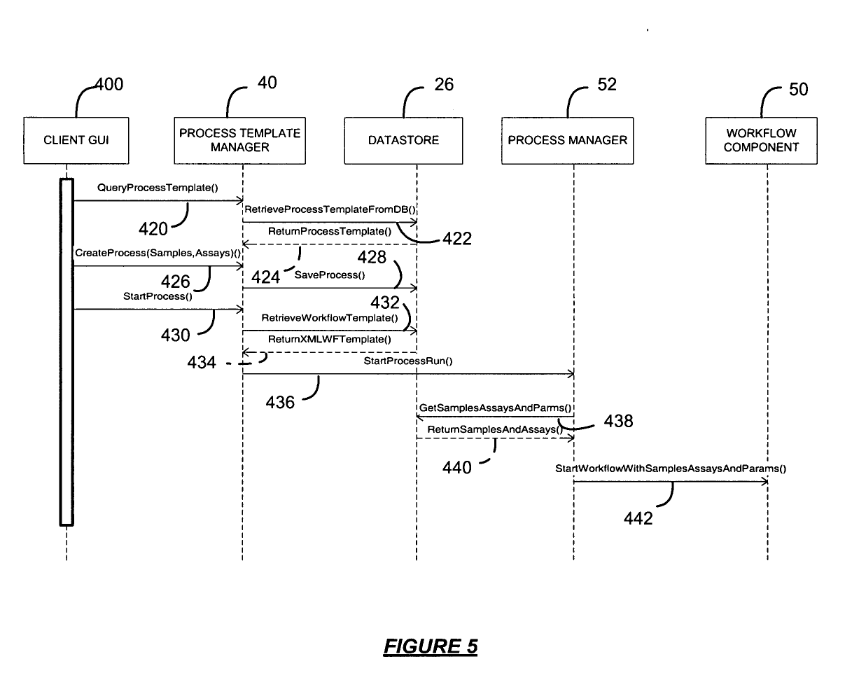

Turning now to FIG. 5, a sequence diagram illustrates the interaction between Process Manager 52, Workflow Component 50, datastore 26, client 400, and Process Template Manager 40. This interaction illustrates the aforementioned sequence of steps in more detail. Client 400 begins by sending query process template command to Process Template Manager 40 at 420. Process Template Manager 40 retrieves the appropriate template from datastore 26 at 422. Datastore 26 returns a Process Template to Process Template Manager 40 at 424. Client 400 then creates a process with the appropriate input objects at 426. The process is stored in datastore 26 at 428.

Client 400 then sends a start process command to Process Template Manager 40 at 430. Process Template Manager 40 retrieves the appropriate Workflow Template from datastore 26 at 432 and 434 and sends a start process run request to Process Manager 52 at 436. Process Manager retrieves the data for the corresponding objects from datastore 26 at 438 and 440 and sends a start workflow command along with the data for the corresponding objects to Workflow Component 50 at 442.

Returning now to FIG. 3, Activity Manager 56 is receptive of Activity User Input Data 60, Activity Definition 28, Activity GUI 30, Object Data 62, Instrument Data 64, and Activity Code 66. Activity Manager 56 is responsible for starting an Activity, querying Activities in the System, and completing an Activity. Activity Manager 56 provides as output Query Data 68 and Activity Panel Data 69 that is viewable by a user via a Lab Console GUI. Activity Manager 56 interacts with Workflow Component 50 to establish Workflow Job Queues and Job Requests to provide all of the above services. Activity Manager 56 provides activity status event messages and pre-configured notification messages represented by 74 to Event Manager 70 and Notification Manager 72, which output event data 76 and notification data 78.

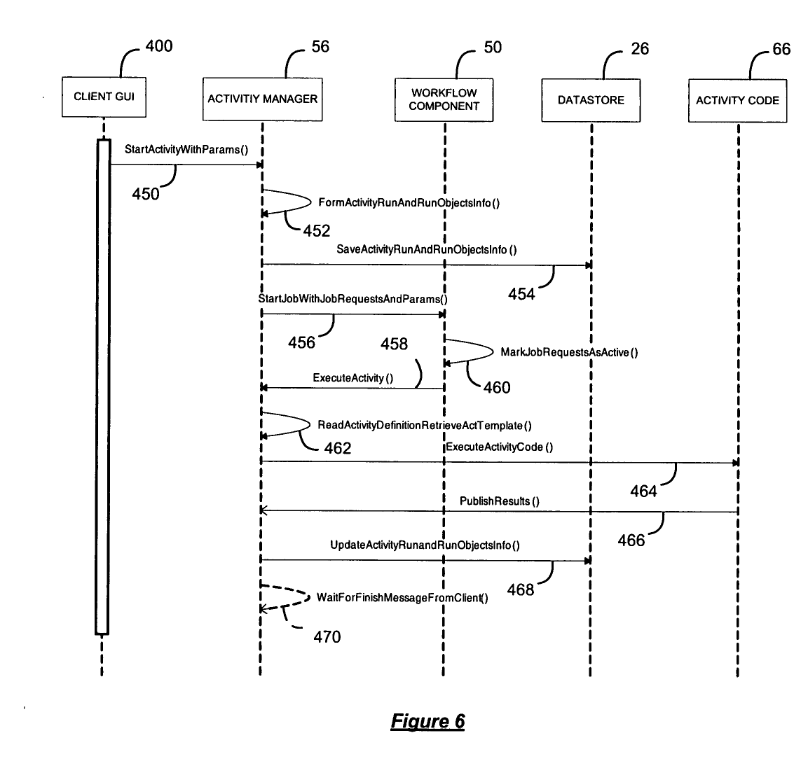

Turning now to FIG. 6, a sequence diagram illustrates the start events of Activity Manager 56. The user can, via a Lab Console GUI running on client 400, enter the appropriate user information, the instrument information, and the Containers or objects waiting in the Activity to be processed. The user also enters the Activity/Task information he wishes to perform, either implicitly or explicitly. Along with the above mentioned information, the Lab Console GUI can send in additional information like, an ad-hoc SOP (Attachments, Microsoft Word files, etc.), run-time attributes, Reagent Info, analyst info, instrument info etc, that are used and specific to the Activity Instrument Run.

Client 400 sends a start activity command message along with the user entered parameters to Activity Manager 56 at 450. Upon receiving this information, the Activity Manager 56 formulates activity run and run objects at 452 from the information entered. Activity Manager 56 stores the Activity Run and Run Objects in datastore 26 at 454. Activity Manager 56 starts a job by sending a job request and corresponding parameters to Workflow Component 50 at 456. Workflow Component 50 marks the job request as active at 460 and in turn sends an execute activity command back to Activity Manager 56 at 458.

Activity Manager 56 reads the Activity Definition and retrieves the corresponding Activity Code 66 at 462. Activity Code 66 can be a program written by an end-user developer. The software in this program can interact with the necessary Domain Service Providers(s) (DSP) like SampleManagement, ConsumablesManagement or the InstrumentLayer directly or through the DSP-Framework service utility. Activity Manager 56 sends an execute activity code command to Activity Code 66 where the code is performed at 464. Activity Code then publishes the results at 466. Activity Manager 56 updates activity run and activity run objects information in datastore 26 at 468. After updating activity run and run objects information in step 468, Activity Manager 56 waits for a finish message from client 400 at 470.

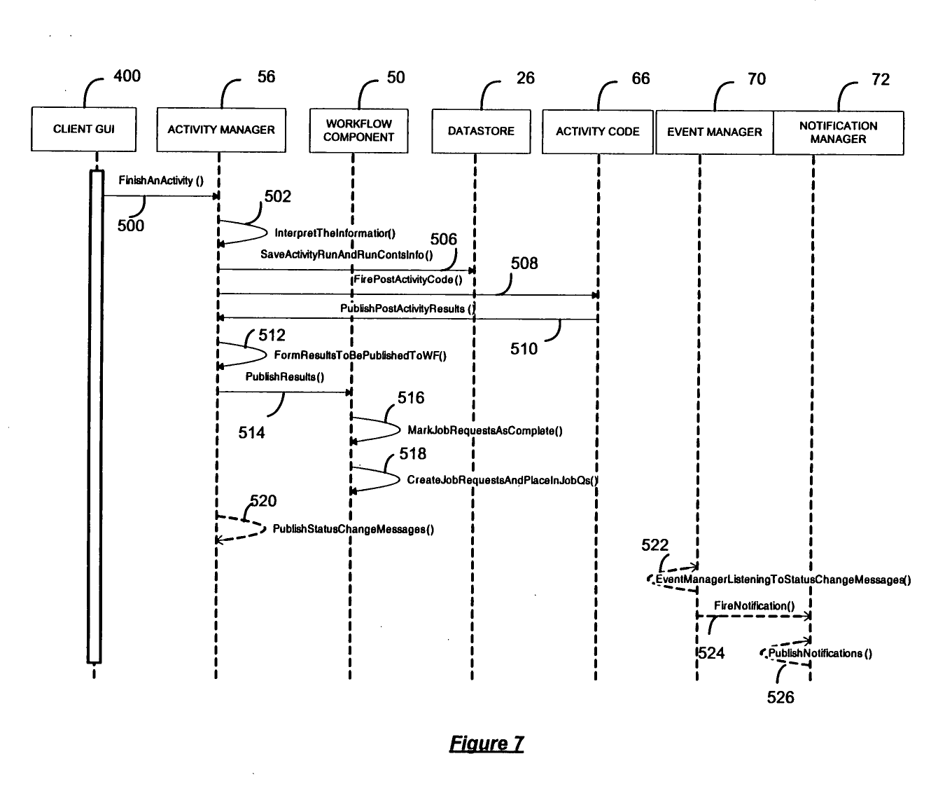

Turning now to FIG. 7, a sequence diagram illustrates the finish steps of Activity Manager 56. Client 400 sends a finish activity command message 500 to Activity Manager 56, which responds by interpreting the information at 502 and saving activity run and run contents information in datastore 26 as at 506. It also fires a post activity code message to Activity Code 66 at 508, which results in publication of a posting of activity results to Activity Manager 56 as at 510. In turn, Activity Manager 56 determines the form of the results to be published to the workflow at 512, and publishes the results to the Workflow Component 50 at 514. Next, the Workflow Component 50 marks the job request as complete at 516, and creates a next job request and places it in the queue at 518. Meanwhile, Activity Manager 56 publishes status change messages at 520. Event manager 70 listens for these messages at 522 fires notifications to Notification Manager 72 at 524, which in turn publishes the notifications at 526.

Returning now to FIG. 3, Activity Manager 56 can query and provide query data 68 to at least one Lab Console via Lab Console GUI of Activities waiting to be processed with the objects currently in a queued state and to maintain the state of the Activity instance(s) of a process run. To fetch the appropriate results for the above mentioned query the Activity Manager 56 interacts with Workflow Component 50 and retrieves all the Jobs across all the Workflow instances with the necessary query criteria. It also retrieves all the Job Requests that are accumulated in the Queues of the Jobs. The Activity Manager 56 interprets this information, generates the appropriate Activity-Process/Process Runs-Containers information and sends it over to a Lab Console GUI. Activity Manager 56 and Workflow Component 50 can provide the requested information all at once or in bits and pieces.

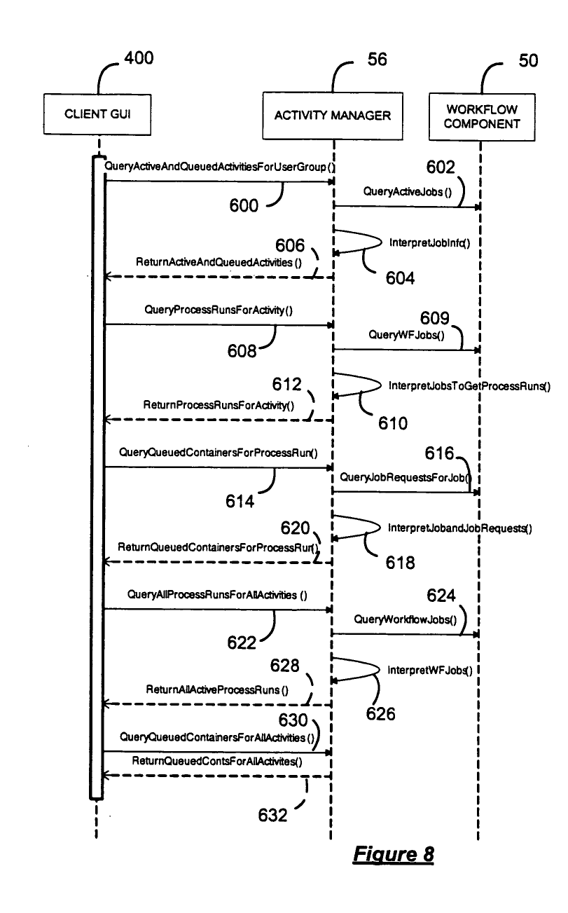

Turning now to FIG. 8, a sequence diagram illustrates one way of querying Activities, runs and Containers as performed by Activity Manager 56 interacting with client 400 and Workflow Component 50. Client 400 sends a request to query for active and queued Activities for a particular workgroup to Activity Manager 56 at 600. Activity Manager 56 queries active jobs from Workflow Component 50 at 602. Job information is then interpreted by Activity Manager 56 at 604. Activity Manager 56 reports the active and queued Activities to client 400 at 606. Client 400 sends a request to query process runs for a particular Activity to Activity Manager 56 at 608. Activity Manager 56 queries workflow jobs from Workflow Component 50 at 609. The jobs yet to be processed are interpreted by Activity Manager 56 at 610 and reported to client 400 at 612.

Client 400 sends a request to query queued objects for a particular Activity to Activity Manager 56 at 614. Activity Manager 56 queries the job requests for jobs from Workflow Component 50 at 616. The jobs and job requests are interpreted by Activity Manager 56 at 618 and reported to client 400 at 620. Client 400 sends a request to query all process runs for all Activities to Activity Manager 56 at 622. Activity Manager 56 queries all workflow jobs from Workflow Component 50 at 624. The workflow jobs are interpreted by Activity Manager 56 at 626 and reported to client 400 at 628. Client 400 sends a request to Activity Manager 56 to query objects for all Activities 630. Activity Manager 56 reports objects for all Activities at 632.

Returning now to FIG. 3, Event Manager 70 listens and acts upon status change event messages 74 posted by Process Manager 52 and Activity Manager 56. Event data 76 is output to a user via an Event GUI. Notification Manger 72 listens and acts upon notification messages 74 posted by Process Manager 52 and Activity Manager 56. Notification data 78 is output to a user via a Notification GUI.

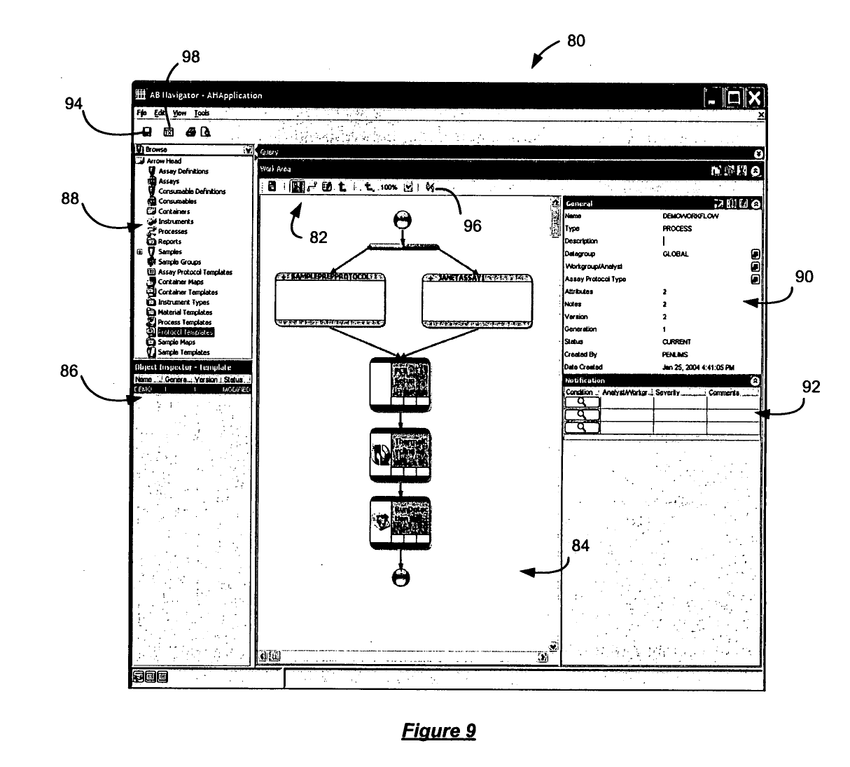

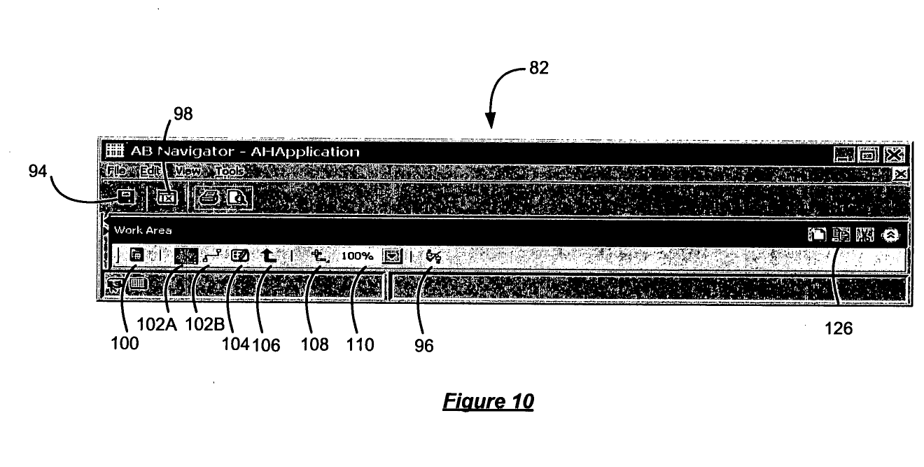

Referring now to FIGS. 9 and 10, the Template Editor GUI controlled by the Process Template Manager is described in more detail. Process Templates, Protocol Templates, and Assay Protocol Templates (hereinafter referred to as templates) are defined using a Template Editor (TE) graphical user interface 80. Processes and protocols can be created, stored and reused, or can be combined with other activities and/or protocols to form more complex process or protocol templates. TE interface 80 can include a toolbar 82, a work surface 84, an object inspector sheet 86, a navigation panel 88, a property sheet 90, and a notification sheet 92.

Work surface 84 provides space for the user to graphically create a template. Graphical objects that make up the template can be dragged and dropped onto the work surface 84. For each object placed onto the work workface 84, when selected, property sheet 90 displays for that object corresponding object properties. The user can fill in the required and optional properties for that object. The Software validates the required properties for the objects at the time a save button 94 or a compile button 96 is clicked. The user can delete one or several existing objects on the work surface 84. Several objects can be deleted by selecting around a region of objects and clicking on a delete button 98.

The toolbar 82 of the TE 80 can include a tool palette button 100, one or more line connector buttons 102A and 102B, an edit protocol button 104, a back button 106, an expand/collapse button 108, and a zoom droplist 110. The tool palette button 100 provides the user with an interface to all pre-defined Activities, Protocols and Controls generally referred to as process objects stored in the datastore. The user can drag and drop process objects from a palette onto the work surface 84.

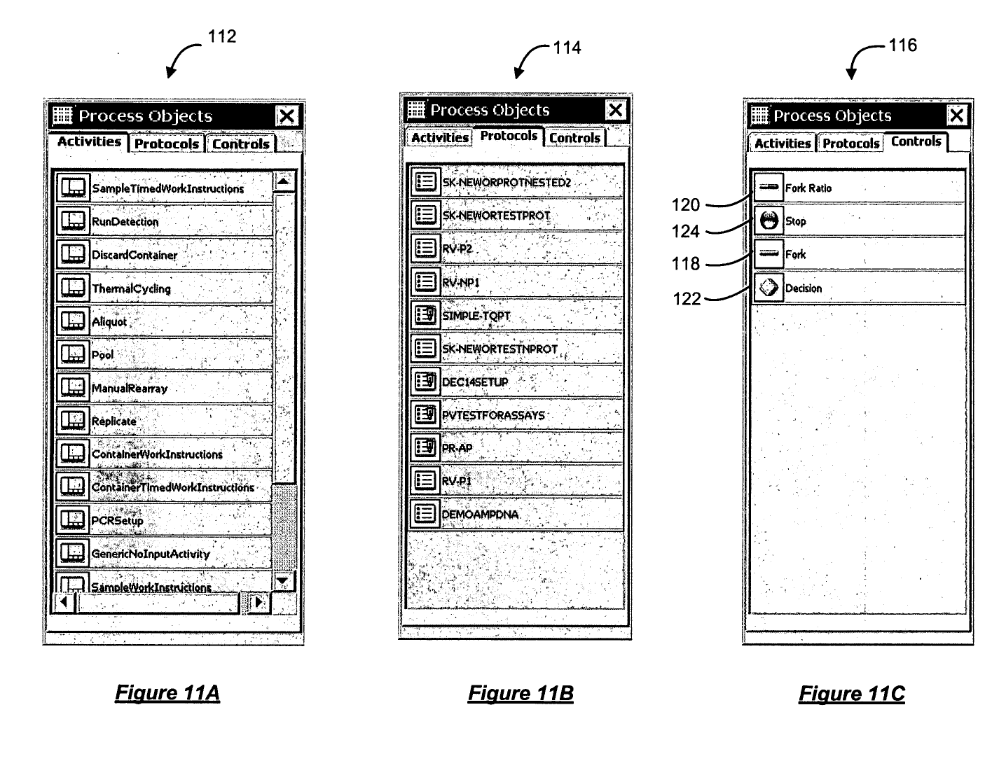

FIG. 11A illustrates an Activities Tab 112 of the tool palette. All Activities can be single pre-defined units of work to be performed. Types of Activities can be: timed, non-timed, and no-input. A timed Activity has distinct start and finish instructions. Examples of this kind of Activity in the present teachings include Aliquot Samples, Run 7900 Detection, and Perform PCR Setup. A non-timed Activity only has finish instructions. Examples of this kind of Activity according to the present teachings include Discard Container and Manual Rearray Samples. A no-input Activity has no starting object. It is also a non-timed Activity. The output of a no-input activity can be objects that continue to the next step in the workflow. An example of a no-input activity according to the present teachings is Get Assay Containers.

When a user drags and drops an Activity onto the work surface of the TE interface, the Software can allow the user to specify the specific parameters of the Activity. Some parameters can be an activity name, an activity input and an activity output. Each Activity having containers as input can include information regarding what type of container to expect, or any. In order for an Activity to specifically identify its expected inputs, and differentiate between activities expecting Sample containers verses those expecting Assay containers, the containers can be identified by Content. The defined types can be Assay, Sample, Mixed, Empty, and Consumable (Reagent). This list can be extensible by activity developers. Activities like Discard Containers have no restriction on what type of containers it can accept.

FIG. 11B illustrates a Protocols Tab 114 of the tool palette. A Protocol is a named collection of Activities, which can have a defined linear, parallel, and/or iteratively looping sequence in a Protocol. Such a collection is useful when multiple steps are repeated or are common to more than one process. Such collections are reusable. FIG. 11C illustrates a Controls Tab 116 of the tool palette. A Control is a flow structure that directs the flow of Activities and Protocols. A Control can be a fork 118, a fork ratio 120, a decision point 122, and/or a start/stop node 124. A fork can be used when a single process forms two or more parallel processes, each executing independently. Returning to FIGS. 9 and 10, by placing a fork point into the work surface 84, the TE interface 80 allows the user to define a collection of process flows, all based on the input leading into the fork point.

A fork ratio is used to cause invocation of separate subpaths through processes, based on the number of objects flowing through a controlling path. For example, if a particular plate of assays can support four plates of samples, the user can insert a fork ratio, to invoke an assay plate preparation flow after each four containers flow through the controlling path. A fork and a fork ratio can be configured using the following parameters: number of arms, logic, name, operator and/or value.

A decision point allows the user to direct the laboratory workflow, based on the results being generated as part of the workflow. Any evaluation that evaluates to a logical TRUE can take the TRUE path, while any scalar expression that evaluates to FALSE can take the FALSE path. The user can use the Line Connector tools to connect the various objects, and configure decision points to indicate the process flow. The user can modify the conditions of the branch to determine where the output process should proceed in the workflow. The decision point can be configured using the following parameters: name, operator, value, and/or join clause. The join clause allows multiple clauses to be joined and evaluated as a single condition.

Start nodes and stop nodes are used to begin and end the flow of the process/protocol respectively. When the editor is invoked, the start node is automatically placed onto the work surface. The user can drag and drop a stop node where the process or protocol is to be completed.

Line connector buttons 102A and 102B allow the user to choose from line connector methods including a standard straight line and a ninety degree line. The buttons selected affect how the connector lines are drawn between process objects. To manage the laboratory process, each object can be constrained to link to another object in order to represent a true process. A loop can be constructed by putting a line connector between an end point activity, and an activity earlier in the workflow. Within the loop, a decision point can be added to allow exit from the loop. When a loop is placed into the workflow, the original object is passed back through the loop. Activities with no inputs cannot have loops back to them. Loops cannot cross protocol boundaries. However, loops can be inserted within a protocol.

An edit protocol button 104 allows the user to select and open a Protocol for editing. Once the edit protocol button 104 is clicked, the work surface 84 is replaced with the contents of the chosen Protocol. The user can then make structural changes to that Protocol in the context of the current template. After the user has optionally made modifications to the Protocol in the context of that template, the user can press a back button 106 next to the edit protocol button 104 to return to the original template, with the new structure in place. The System allows the user to save the changes upon return to the original template.

An expand/collapse button 108 allows the user to expand and collapse protocol objects within the work surface 84. A user has the option when clicking on the expand/collapse button 108 to expand all objects within the context of the currently-open process, expand a selected object, collapse all objects within the context of the currently-open process, or collapse a selected object. The zoom droplist 110 allows the user to select the zoom percentage of the work surface, from the following list of percentages: 10, 25, 50, 75, 100, 150, 200.

A compile button 96 allows the user to compile the newly constructed template. During compilation, the editor determines the validity of the template, verifying that all required fields are filled in, the rules with regards to entry and exit points are enforced, and the expected inputs to an activity match the outputs coming from previous activities. The editor can indicate any error conditions to the user for corrections. Errors or an indication of success are displayed in an Error Pane Window (not shown) below the work surface 84. Upon user selection of an error, the corresponding object to which the error pertains is highlighted and an appropriate message is displayed. If there are no compilation errors, the template can automatically be saved.

The elements of the properties sheet 90 are now discussed in more detail. Object properties can be name, type, description, data group, workgroup/analyst, attributes, notes, version, generation, status, created by, and date created. Each object of the template can be defined by a name, type and description. The user who creates a Process or Protocol can be a property as well as the date the Process or Protocol is created. Each object of the template can be assigned a datagroup and a workgroup/analyst. A datagroup defines a group of users who can have access to the Process, Protocol, or Activity. A workgroup/analyst is a specific lab technician or work group that the Activity or Protocol can be assigned. These attributes can either be inherited from the template being created or the user can enter in a specific setting for each object. A user cannot insert or edit a Protocol to which they do not have datagroup access to all of the Activities and Protocols within it. The user can view instances of the Process in a Process Viewer (not shown), but cannot view the details of objects to which they do not have datagroup access.

When the user modifies the workgroup/analyst settings at the template level, the Software can prompt the user whether to apply the setting to all Activities and Protocols within that template and override the previous settings. If the user does not choose to override the previous settings, then the Software cannot update the values. If the selected workgroup/analyst does not have datagroup access to one of the Activities or Protocols within template, the analyst cannot be assigned to that Activity or Protocol.

For Protocol Templates inserted into the new template by the user, all of the original settings saved with the Protocol Template can be copied over. The user can bring up the property sheet for the Protocol, or the Activities within the Protocol, and make explicit changes to the settings. These changes can not automatically be reflected to the saved version of the Protocol Template that was inserted.

Templates can be issued a version according to an extended versioning model which is not limited to a simple version increase (e.g., version 1 increased to version 2), but uses a concept of a major and a minor change. Templates and objects have two attributes, a generation (major change/version) and a version (minor change/version). Hence, changes determined by the user or the Software to be deemed significant can increase the generation number while changes that are considered to be minor, or insignificant can increment only the version number. This allows for various degrees of approval. When a new template is saved for the first time, the template can be labeled as Generation1, Version 1, and status NEW.

The status of a template can be NEW, APPROVAL PENDING, CURRENT, or MODIFIED. The user can make a NEW generation by manually selecting a ‘New Generation’ operation from a menu droplist. This can only be done if there is not already a NEW or APPROVAL PENDING record for the template. The following scenario illustrates what portions of a template can be replicated when a new version or generation is created:

Process Template T1:

TABLE 1

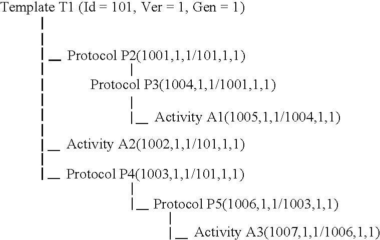

| Template | Template | Template | | | |
|---|---|---|---|---|---|
| Id | Ver | Gen | Type | Name | Status |
| 101 | 1 | 1 | PROCESS | T1 | CURRENT |
| 102 | 1 | 1 | PROTOCOL | P2 | CURRENT |
| 103 | 1 | 1 | PROTOCOL | P3 | CURRENT |
| 106 | 1 | 1 | PROTOCOL | P4 | CURRENT |
| 107 | 1 | 1 | PROTOCOL | P5 | CURRENT |

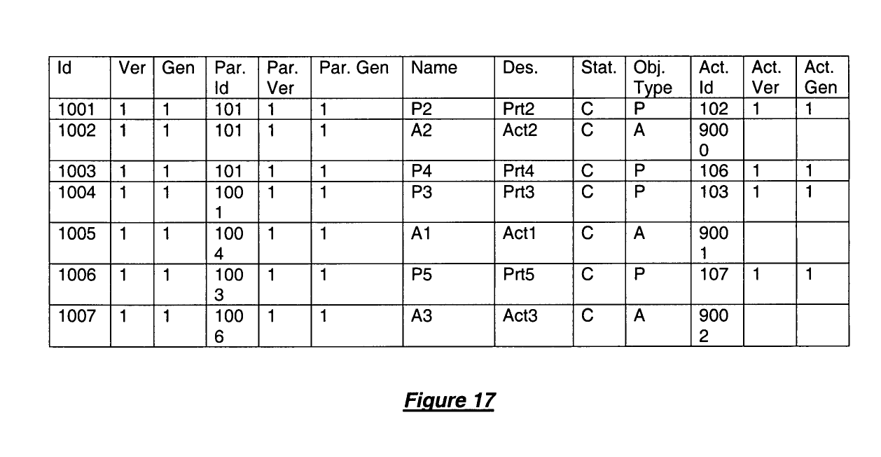

A History table can be generated for each template based on the version and generation. With each process and activity instance created for a process and its process runs, a link to the template can be included in the history. The history table(s) can include a column to identify the ID, version, and generation of the Process/Activity template used to create it. FIG. 17 is an example of a history table of this kind.

Alternatively, after modification of an existing template the user can click on the save button 94. Upon execution of the save operation, the Software can determine whether to make a NEW version or save as CURRENT, and can proceed to do so. The resulting tress demonstrates when a NEW version is created by modifying the template.

Resulting Tree:

TABLE 2

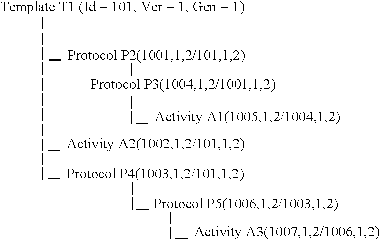

| Template | Template | Template | | | |
|---|---|---|---|---|---|
| Id | Ver | Gen | Type | Name | Status |
| 101 | 1 | 1 | PROCESS | T1 | MODIFIED |
| 102 | 1 | 1 | PROTOCOL | P2 | CURRENT |
| 103 | 1 | 1 | PROTOCOL | P3 | CURRENT |
| 106 | 1 | 1 | PROTOCOL | P4 | CURRENT |
| 107 | 1 | 1 | PROTOCOL | P5 | CURRENT |
| 101 | 2 | 1 | PROCESS | T1 | MODIFIED |
| 101 | 3 | 1 | PROCESS | T1 | CURRENT |
| 101 | 1 | 2 | PROCESS | T1 | NEW |

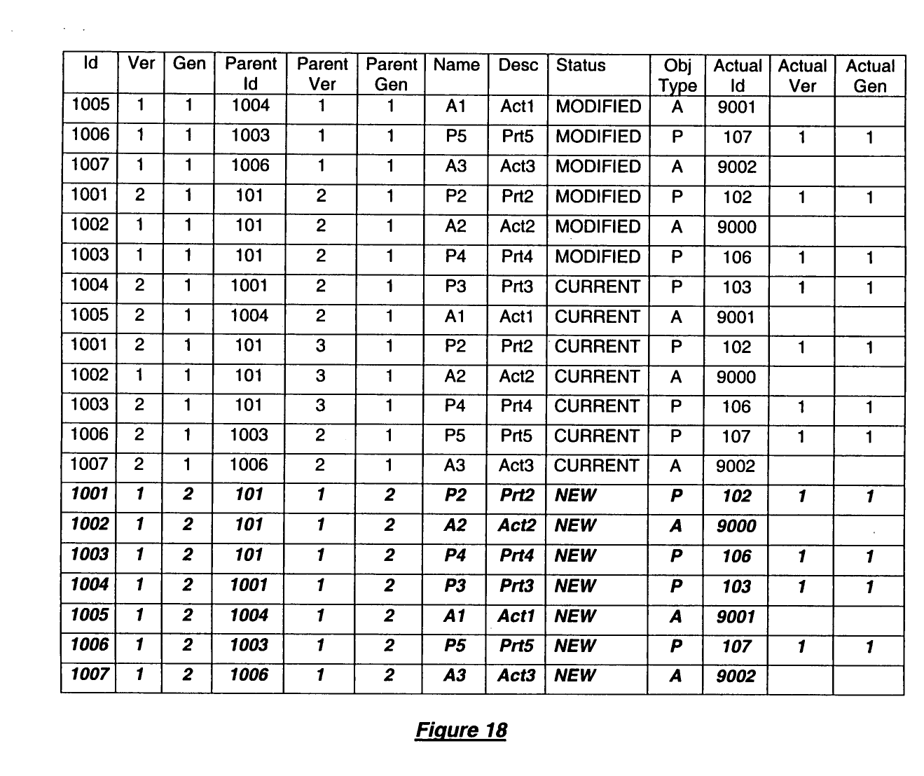

FIG. 18 illustrates a history table for when a new version is created from a modified template. The status of the template remains NEW until the template is put into use after successful compilation. Once the user has finished building and successfully compiles the template, the user can select a ‘Make Ready for Use’ operation form a menu droplist. This operation can also be available from a shortcut menu when a Protocol is open in the editor. When the ‘Make Ready for Use’ operation is selected, if approval is not required, the template status can be updated to CURRENT. If approval is required, the template status can be updated to APPROVAL PENDING until approved.

The user can change a template status from APPROVAL PENDING to CURRENT by selecting an ‘Approve Menu Item’ operation from a menu droplist, or by selecting a shortcut menu when the Protocol is open in the editor. The selection of a ‘Decline’ operation from a menu droplist can return the status of the template to NEW.

Only template objects with a status of NEW or CURRENT can be modified. The user can make any changes to template objects with a status of NEW, including structural changes and modifications to the activity input/output parameters. Changes to template objects with a status of CURRENT can only be made if there is no NEW version or generation of the same template in the system. Modifications to values that can not create a new version, but instead can modify the CURRENT record in place are: changes to analyst/workgroup settings and changes to notifications. Any other changes can cause a NEW record to be created, leaving the previous version/generation at CURRENT. When an existing template with a prior CURRENT version is made ready for use and optionally approved, the new revision can become CURRENT and prior revisions status can become MODIFIED.

Modifying a Protocol Template does not modify any pre-existing Process or Protocol templates that were built with the template being modified. For each pre-existing Process or Protocol, the user can select a ‘Refresh Protocols’ operation from a menu droplist to update the template with the most current versions/generations of the Protocol Template. When this option is selected, the user can be presented with a dialog displaying a list of Protocols and their original version/generation that are used in the current process or Protocol Template. Only top-level Protocols/Assays Protocols can be listed, not those nested within other protocols. The screen can include the following data elements: protocol, name, version, generation, latest version, latest generation, and modified date. The user can then choose to manually delete the old Protocols from the template, and add back the latest version

Templates of status MODIFIED generally cannot be reused. A copy button 126 on the toolbar 82 can save a new copy of the MODIFIED template under a different name. A full replicate of the template can be created. The user can physically delete a template with status NEW. Only that version of the record and its details can be deleted. Older versions/generations can remain and retain their status. CURRENT templates can only be marked as OBSOLETE. All versions of the record and their details can be marked as OBSOLETE. APPROVAL PENDING templates cannot be either deleted, or marked as OBSOLETE. The Delete button 98 on the TE toolbar 82 can be used to delete or obsolete a record. Existing templates can be marked as obsolete without additional validation.

An additional element is added to an activity property sheet 90 to allow entries for a repeat factor. For a given input to an Activity, the object can need to go through the Activity more than once, before moving on to the next Activity in the workflow. For each input object on an Activity, the user can enter a repeat factor value. For example, for the PCR Setup activity, there can be up to three repeat factors: one for Sample containers, one for Assay containers, and one for Reagent containers. For the Aliquot activity, there can be one repeat factor, for the input containers it expects.

Referring now to FIGS. 3 and 9, the elements of the notification sheet 92 and the interaction with the Notification Manager 72 are now discussed in more detail. When the laboratory manager sets up a laboratory process in the Software, or starts a process run, the lab manager has wide latitude in determining what conditions require notification. The Notification Manager 72 can notify the user assigned to the Activity, or to the members of the workgroup assigned to the Activity for each notification condition. If there are different workgroups to notify or several individuals not in the same workgroup to be notified, multiple entries can be created in the notification sheet 92.

The following data elements can be present in the notification sheet 92: workgroup/analyst, notification condition, severity, and comments. The workgroup/analyst field allows for the user to designate either a workgroup or analyst that should be notified if a predetermined notification condition occurs. The notification condition can be elected from a browse button whereby the user can define one or more notification criteria. Notification conditions can be a predefined list. The severity field allows the user to rank the priority of the notification conditions. The comments element allows the user to customize a text message to be appended to the end of the notification message sent when a condition occurs.

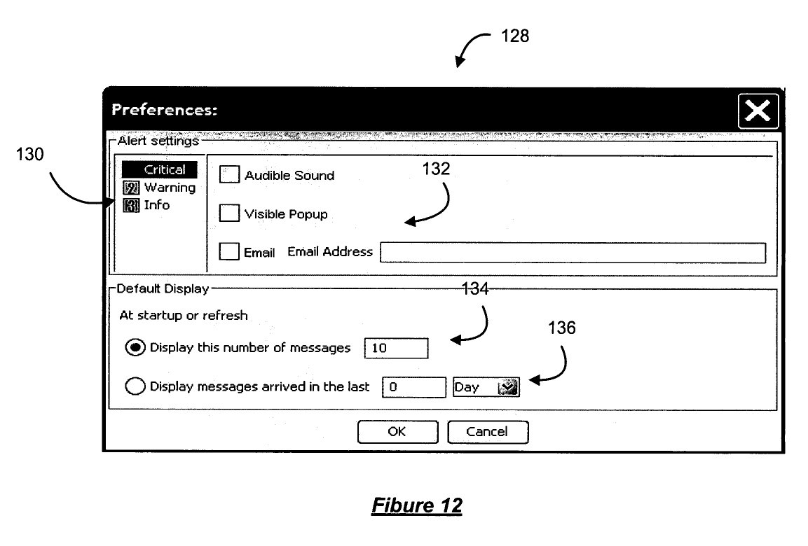

Referring now to FIG. 12, the Notification Manager can allow each user of the Software to access a Notification Preference GUI 128 to configure his personal preferences. The Notification Manager can apply the user preference to all notification messages, allowing each user to specify how a notification should be delivered. The GUI can be available by selecting a ‘Notification Preferences’ operation in a menu droplist.

The message priority level is displayed in a window 130. The user can select, for each message priority level, how a message should be delivered at 132. A message can be delivered by an audible sound, a visible popup, or an email. The notification mechanisms are not exclusive. A user can select to have a message delivered both via a visible popup and an email message. The user can select to have a specified number of messages to be displayed at 134 or select to have messages arrived within a configurable amount of time to be displayed at 136.

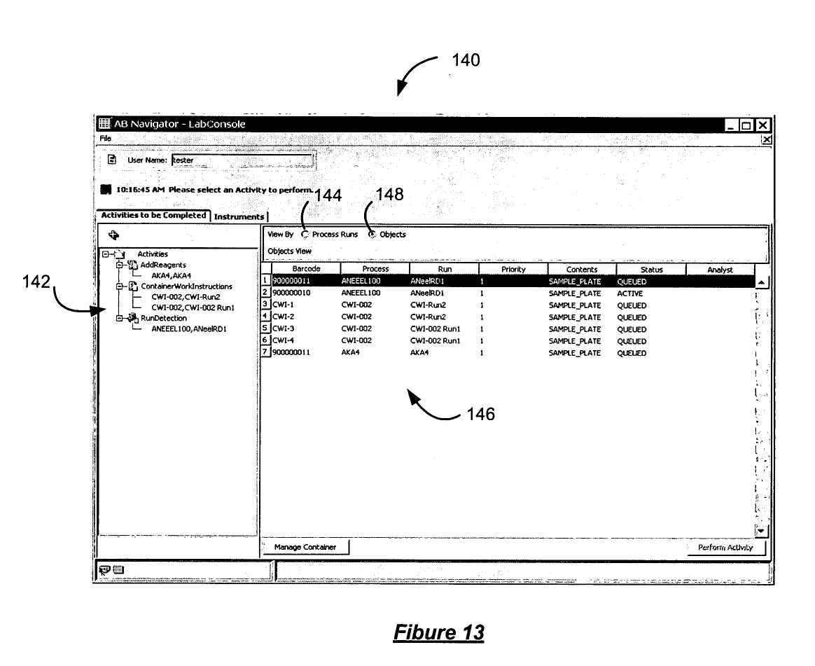

Referring to FIGS. 3 and 13, Activity Manager 56 also provides a Lab Console GUI for a laboratory analyst or workgroup to view Activities assigned to them, view information on resources available for those Activities (e.g. Instruments), view data objects waiting to be processed (e.g. Samples, Containers, Assays) and initiate the Activity. Lab Console GUI is shown generally at 140. The Lab Console GUI 140 displays to the analyst the list of Activities available to work on. The activity nodes displayed are those which the current user can perform, which have QUEUED or ACTIVE objects (e.g. containers/samples) waiting to be processed. Under each Activity in the navigator pane 142, the user can select a Process Run radio button 144 and see the Process and Process Run names which have ACTIVE or QUEUED objects (e.g. containers). With the top-level node selected in the navigator pane 142, all of the process runs are displayed for all Activities.

Alternatively, the user can view the objects that are ACTIVE or QUEUED for an Activity as shown in a dialog box 146 of FIG. 13. When the user selects an activity node from the navigator pane 142 with an objects radio button 148 selected, the dialog box 146 on the right side can display the full list of objects that are QUEUED or ACTIVE on this Activity. The data shown can be across process runs. If the user selects a specific process run, then the list can be reduced to those data objects belonging only to that process run. If the user has selected the top-level node, then the list of data objects can be those across all processes and runs. This interface can be pluggable depending on the kind of input objects the selected Activity expects. Supported directly in the present teachings are the data objects Containers, Samples, and Assays, but the framework is extensible to allow for additional input objects.

The Lab Console GUI 140 includes the capability of viewing resources needed by the Activity. For example, many Activities in the present teachings require the use of an instrument as a resource. For these Activities, the user can specify a type of instrument required by the Activity when setting up the template. The Lab Console GUI 140 provides the list of instruments that can be used for that Activity. When the user selects an Activity or process run node, the list of possible instruments for use by that activity can be viewed. If the instrument is currently active, the Lab Console GUI 140 provides the capability of viewing details about the run, including the data elements, start and elapsed time, and additional information particular to that instrument.

The Lab Console GUI 140 provides an interface for the user to execute the following Activity instructions: start, finish, revert, and cancel. Start allows the System to execute pre-activity and Activity Code and change the object status QUEUED to ACTIVE. Finish allows the System to execute post-activity code. Objects are moved to the next Activity in the workflow. Revert allows the System to execute activity revert code as specified by the activity developer. The object state is set back to QUEUED. For a Cancel instruction, no instructions are sent to the Activity Manager and operation is cancelled.

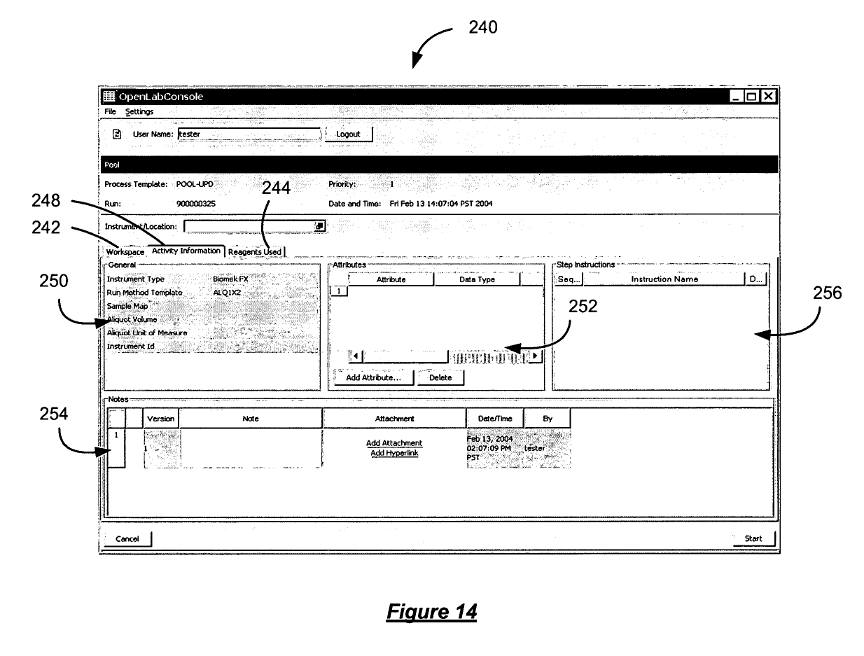

Referring to FIGS. 3 and 14, when the Lab Console is in an idle state, the user can initiate an Activity instruction by executing an Activity Panel GUI 240 and by entering object data 62. Each object of the Activity can be defined by a sequence or order number, an object identification, a unique barcode, an object type, a plate type, and an input or output type. To define the types of objects for a given Activity, first the kind of Activity, timed, non-timed, or no input, is considered. For no input Activities, the object type can always be OUTPUT. An example is the Get Assay Containers Activity, which has the user go get plates full of assay tubes matching the list of assay definitions as defined by the lab manager at the time the process is set up. For that Activity, there are no input objects, but there are output objects with object Type ASSAY_PLATE. For non-timed Activities, where the same object is both input and output, the type is INPUTOUTPUT. An example of this is the Place into Storage Activity, in which the user can identify the new location of the input object (e.g. placing a container into a refrigerator).

For non-timed Activities, where the data objects coming in are different than those going out, there can be objects of type INPUT and OUTPUT. For example, with the Manual Rearray Samples Activity, the individual samples entering the activity are input objects of type SAMPLE, and the rearrayed containers are output objects of type SAMPLE_PLATE.

A container map template defines the mapping from one or more input containers to one or more output containers. Typically, a container mapping is performed by the use of a liquid-handling robot. For timed Activities with container map such as Aliquot Samples, where input Sample Plates come in and new child Sample Plates are output, there can be objects of type INPUT and OUTPUT, both of object type SAMPLE_PLATE. For example, the user can perform a container mapping of one source plate to four destination plates, with four child samples created for each parent sample.

For timed Activities that do not have a container map, such as Thermal Cycling, often the value objects are of type INPUTOUTPUT. In the case of Thermal Cycling, one or more Container objects enter the Activity, and are placed on the Thermal Cycler instrument. The instrument runs, and then after completion, the containers move on to the next step in the workflow. For other timed Activities without container maps, such as Replicate Samples, there are value objects of type INPUT and others of type OUTPUT. In that case, one of the activity parameters (# of Copies) determines the number of output data objects on a given activity run.

For timed activities, there is additionally the possibility of marking an object such as a Sample or Container with a FAILED status. The workflow can then be built to progress FAILED objects through a different path than objects that have not failed. The Lab Console GUI 240 provides the functionality for the user to mark an object as FAILED.

Finally, the object contains additional useful information, including the identifier of the process to which the object is associated, the identifiers of the process workflow template that is being run, and the details of the activity parameters for that object. Activity Manager 56 passes this information between the main Lab Console GUI 37 (FIG. 2) and the pluggable Activity GUIs 30.

Returning to FIG. 3, once a user is ready to execute an instruction, a user can identify the work to perform by entering the barcode ID of the object they are working on. The barcode can be entered by an input device including but not limited to a scanning device, a keyboard, or programmatically determined. Depending on the Activity, the ID can be a Sample ID, Assay ID, Container ID, or Process Run ID, or other objects for which the System can be extended. Once the ID of the object is entered, Activity Manager 56 determines if the ID is for a valid object currently in one or more processes. If not, an error condition is raised.

If the ID is present in more than one process queue, then the user can be forced to select which process run they are currently working on. For example, a parent sample ID might be scheduled for more than one process, and be waiting in the queue for both at the same time. (e.g., Genotyping, Gene Expression workflows). Once the appropriate Activity is selected for the object, Activity Manager 56 can determine the Activity, and whether we are in the start or finish mode. Activity Manager 56 can then determine and display the appropriate Activity GUI 30 (FIG. 2), based on the state of the object on that Activity, and based on the information provided for the Activity GUI 30 by the activity developer in the definition. The user can then perform the start or finish, and the Activity Manager 56 (FIG. 3) can process the information.

Turning to FIGS. 14-16, an Activity Panel GUI for an Activity is shown generally at 240. The graphical user interface includes four areas, a workspace tab 242, reagent/consumable information tab 244, a sample results tab 246, and an activity information tab 248. The workspace tab 242 displays the Activity GUI. The Activity information tab 248 displays and allows modification of the Activity input parameters, attributes, notes, and step Instructions.

FIG. 14 shows the activity information tab of the Activity Panel GUI 240. The general region dialog box 250 displays the runtime parameters for the Activity, specified on the activity definition, with values provided from the Workflow Template. The user can modify updateable run-time parameters for the Activity. For example, if the lab manager has marked the Run Method Template run-time parameter as updateable, then the interface can allow update on that data attribute. For non-updateable run-time parameters, the user can view the values. Additionally, an Activity GUI can display runtime parameters directly on its interface. For example, the Discard Containers activity GUI displays the Location runtime parameter directly on its interface. Location is then accessible from both the Activity GUI on the workspace tab 242, and from the general region dialog box 250 of the Activity information tab 248.

The user can view and edit attributes from the attributes region dialog box 252 of FIG. 14. When a given activity is selected, there can be more than one activity instance object, representing one or more processes/runs, for the objects waiting in the activity queue. On an activity within the process/protocol template, there are attributes on the template. At process set-up, the user can edit one or more attributes at the activity level for that specific process and its runs. Hence, the activity instances can have different attribute values. From this tab, since there can be more than one process represented by the objects queued on a given Activity, there can be a radio button (not shown) with two values, activity template attributes, and instance attributes.

The activity template attributes are displayed by default. The panel can show all the attributes and their values that were defined by the Process Template. The attributes can be displayed for view only. When the Instance Attributes radio button is selected, the list of Processes that are waiting at that Activity can be displayed. When the user selects on of the processes in the list, the present teachings can display the instance attributes for that Activity in that process.

The user can add and edit notes from the notes region dialog box 254. Notes include external documents attached such as SOPs, instructional information, as well as information gathered during the activity run (e.g. Spreadsheet containing computed data, image files, instrument log files, etc). Notes defined on the Process Template can be read only. Similar to attributes, since there can be more than one process represented by the objects queued on a given Activity, there can be a radio button (not shown) with two values, activity template notes, and instance notes. The user can then view the notes from the template, view the notes created at process setup for that activity, and add new notes for this run. The Notes are stored in datastore along with the data for the activity run.

A Workflow Template can be defined with simple instructions for performing the Activity. A step instructions dialog box 256 allows the lab analyst to view the instructions. Additionally the System provides for these instructions to be downloaded to a wireless device or other client.

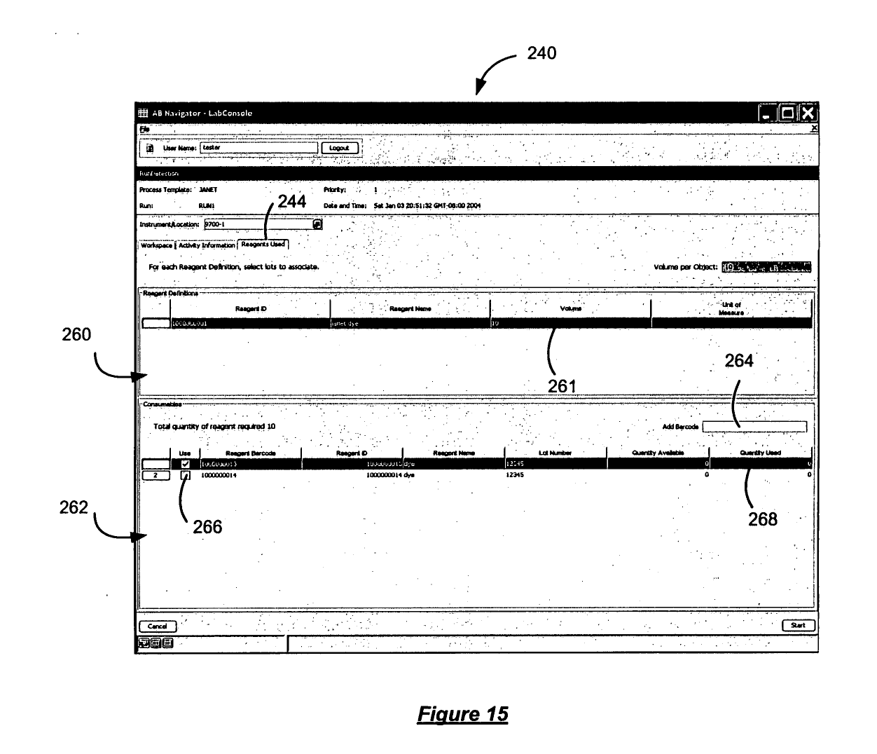

FIG. 15 shows a reagent/consumable information tab 244 of the Activity Panel GUI 240. The GUI provides functionality for Reagent/Consumable usage to be recorded, and inventory to be managed. If the Activity template had reagents/consumables associated with it, then upon activity completion, the user can enter the consumable instance information that was actually used within the activity (e.g. which specific Lots of consumable were used). Alternatively, the user can enter the information at start of a time-based activity if it is known at that time. The user can scan in the barcode identifier of each consumable used, or manually select them from the defined list. The user can update the actual quantity used if the flag on the template is set for that reagent.

The GUI displays the reagent definitions expected in the Reagent Definitions region 260. The Volume per Object field 261 displays the quantity required for each data object (e.g. container) in the activity run.

The Consumables region 262 displays the list of reagent instances available in the system corresponding to the selected definition. The user can scan in reagent barcodes used in the add barcode field 264. When the user scans in a barcode, the corresponding row in the table is highlighted and the use checkbox field 266 is checked. Instead of scanning in the barcode, the user can manually check the use checkbox field 266. A quantity used field 268 allows the user to enter manually a value for how much of that reagent was used. By default, quantity used is computed by the system. This is done based on the quantity available for that reagent instance, and the quantity required by the activity run.

When the user has selected enough reagent to make up the total quantity required, the user can not be able to select additional instances. To select additional instances, the user can need to change the Quantity Used from one of the selected instances so that there is still some quantity that needs to be specified. If there is no inventory information for the reagent instances, the present teachings can allow the user to scan in any number of instances. Each instance used can be loaded into each well of each container. For reagents tracked in inventory, the present teachings can decrement the quantity used for each instance. A message can be displayed to the user if they leave reagent information missing at the time of completion of an activity. The user can not be prevented from finishing the activity.

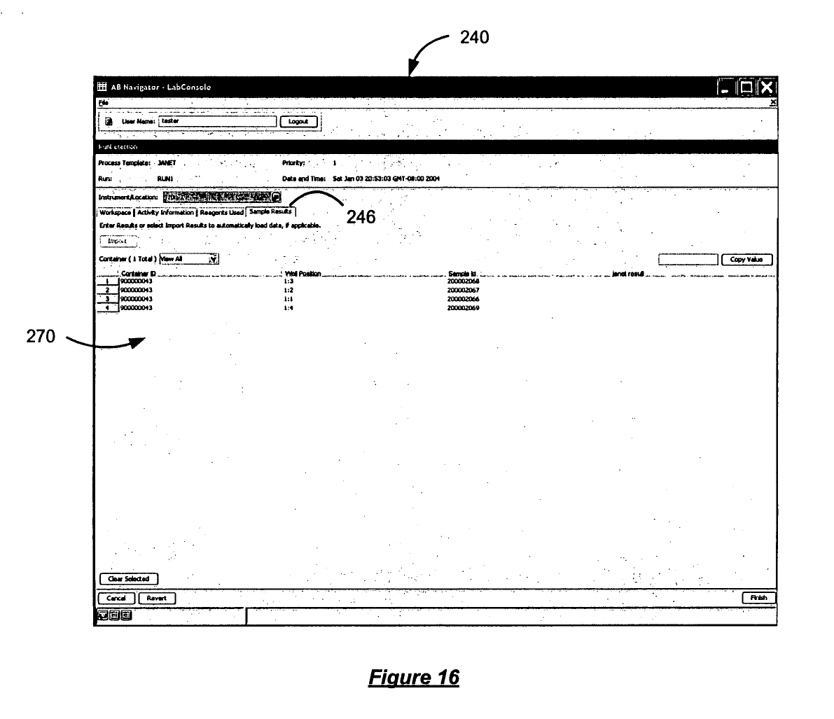

FIG. 16 shows the samples results tab 246 of the Activity Panel GUI 240. For each sample in the activity run, each result is listed. If containers are going through the Activity, then the container ID and well position is displayed. If individual sample objects are going through the activity, there is no container information. The container list box 270 displays all of the container Ids within the activity run. The user can filter the list of samples/results by selecting a specific container from the drop list.

For each sample result, an additional column is added to the left of the sample ID. If a sample has multiple results, there can be additional columns that can be scrolled to the right. The user can manually type in result values, or select multiple cells, and enter a copy value. Result values entered can be compared against plausibility limits. If results are out of limits, they can be flagged. If the override limits flag has been set on the result template definition, then the user can save the out of limits results, overriding the limits. If the override limits flag is not set, then the user can be forced to modify the value before being able to save the data.

The user can manually enter a note/attachment instead (or in addition to) a result. The user can select one or more result cells to invoke a standard notes dialog box. The user can then enter one or more notes, and dismiss the notes dialog box. The notes added can be added to all of the selected result cells.

The System provides a facility to allow importing of result values. For example, after a container is run through the 7900 Sequence Detection System, the user can wish to import the resulting Genotyping or Gene Expression result values corresponding to the samples within that container. The System provides integration with a Result Import facility, which provides a defined interface for developers to write result parsers for specific instrument data resulting from a run. A parser conforming to that interface can be developed and can then directly work with the System. When the user has selected a result file to import, the result file can be parsed, and the resulting result values can be displayed within the sample results tab 246 of the Activity Panel GUI 240, the same as when results are manually entered. Result data can be validated, and any results outside of plausibility limits can be highlighted. The user can then modify the result values before saving, and/or enter any results manually that were not part of the file.

Returning to FIGS. 2 and 3, the System 32 is a fully automated environment with well-defined interactions with lab Processes and Activities, including interactions with lab instruments. The System 32 provides a central place for a laboratory analyst to create, view and perform work, and view resources availability needed to perform that work. New Activities Definitions, and Activity GUIs 30 (tasks, laboratory operations) can be added to the System 32 by simply creating XML descriptors of the necessary instructions, and implementing the defined interface for displaying a UI to an interactive user for interacting with the System 32. Thus, the System 32 is easily extended and customized, capable of performing new tasks with minimal effort without any changes required to the base system. The System 32 is designed to readily be extended to support new types of objects and new kinds of resources. Finally, the System 32 can be configured for multiple modes of deployment, including both a shared console approach, or targeted to an individual user, and/or extended to additional future modes of deployment.

Those skilled in the art can now appreciate from the foregoing description that these broad teachings can be implemented in a variety of forms. Therefore, while the teachings have been described in connection with particular examples thereof, the true scope thereof should not be so limited since other modifications will become apparent to the skilled practitioner upon a study of the drawings, the specification and the following claims.

1. A laboratory information management system, comprising:
a process template manager that creates a process template from a plurality of activities;
a workflow template generator that generates a workflow template from said process template;
a process manager that starts a process run according to said process template;
a workflow component that schedules workflow according to said workflow template; and
an activity manager that controls execution of an activity according to said process template and said workflow template.

2. A system of claim 1, wherein said activities are predefined and stored in a datastore.

3. A system of claim 2, wherein said datastore stores said process templates and said workflow templates.

4. The system of claim 1, further comprising an event manager that listens for and provides notification of status change events of said activities.

5. The system of claim 1, further comprising a notification manager capable of configuring and publishing a notification message.

6. The system of claim 1, wherein said process template manager creates protocol templates.

7. The system of claim 1, wherein said activity manager further comprises a lab console graphical user interface that permits a user to perform a start, a stop, a revert, and a cancel of said activities.

8. The system of claim 1, wherein said activity manager further comprises a lab console graphical user interface that permits a user to perform a query of said activities of the system.

9. The system of claim 1, wherein said process template manager further comprises a process template editor graphical user interface that permits a user to create said process template.

10. The system of claim 9, wherein said process template editor graphical user interface permits a user to create said process template from said activities, protocol templates, and at least one control.

11. The system of claim 10, wherein said control can be at least one of a fork, a fork ratio, a start node, a stop node, or a decision point.

12. The system of claim 9, wherein said process template editor graphical user interface permits a user to configure and start a process run.

13. The system of claim 9, wherein said process template editor graphical user interface permits a user to configure notification messages.

14. The system of claim 1, wherein said activities can be a single unit of work to be performed.

15. The system of claim 1, wherein said activities can be performed on laboratory objects.

16. The system of claim 15, wherein said objects can be at least one of a container, a sample, or an assay.

17. The system of claim 1, wherein said activity manager sends instructions to an instrument.

18. A laboratory information management method, comprising:
creating a process template from a plurality of activities;
generating a workflow template from said process template;
configuring said process template to run;
running said process template;
scheduling workflow according to said workflow template; and
executing activities of said process template.

19. The method of claim 18, further comprising publishing a notification message.

20. The method of claim 18, further comprising publishing a status change event of said activities.

21. The method of claim 18, wherein said step of creating a process template can be performed from a protocol template and a control.

22. The method of claim 18, further comprising generating history trees from said process templates.

23. The method of claim 18, wherein said step of configuring a process template to run comprises:
configuring an input object for said activity;
configuring an output object for said activity; and
configuring a time of execution for said activity.

24. The method of claim 23, wherein said input object can be configured to be no input and said output object can be configured to be no output.

25. The method of claim 18, further comprising querying said activities of the system.

26. The method of claim 18, further comprising querying a workflow schedule and workflow job queues.

27. The method of claim 1, wherein said step of executing an activity further comprises entering a barcode for an object of said activity.

28. The method of claim 1, further comprising storing said protocol template in a datastore according to a version and a generation.
